(19) United States
(12) Patent Application Publication
(10) Pub. No.: US 2003/0005320 A1
(43) Pub. Date: Jan. 2, 2003

(54) Electronic security information management method and recording medium using an IC card

(75) Inventors: Shinji Matsune, Aki-gun (JP); Shouzou Fukuya, Tokuyama (JP); Hiroshi Nitta, Hiroshima (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/108,389

(22) Filed: Mar. 29, 2002

(30) Foreign Application Priority Data
Jun. 27, 2001 (JP) 2001-194581

(51) Int. Cl. H04L 9/32

(52) U.S. Cl. 713/193

(57) ABSTRACT

An electronic security information management method and recording medium using an IC card to prevent data leaks by a dishonest third party who is carrying, a secret data recorded on an information processing apparatus, such as a computer, integrated circuit card, floppy disk, or other recording medium to the outside of an organization. The electronic security information management method and recording medium can deter the use of the data copied to a recording medium by the dishonest third party and will also record and allow for later inspection the processes used for copying the data to the recording medium. The information management method includes accessing a authorization medium, when copying a data recorded in a first recording medium in an information processing apparatus to a second recording medium and executing the copying when an authorization permitting the copying from the first recording medium can be read from the authorization medium or refusing the copying when the authorization cannot be read.

### CROSS-REFERENCE TO RELATED APPLICATION

This application is related to and claims the priority under 35 U.S.C. §119 of Japanese Application number 2001-194581, filed Jun. 27, 2001, the entire contents of which is incorporated by reference herein.

### BACKGROUND OF THE INVENTION

1. Field of the Invention

The present invention relates to an information management method for deterring data leaks, enabling a search and inspection of the data when data is copied to a recording medium from a personal computer within an organization and a search of the records of the process used to copy the data to the recording medium.

2. Description of the Related Art

Important data of an organization is generally specified with an implementation rule and regulated so it may used only for the limited purposes within the organization. When it is requested to use such data outside the organization, a user intentionally encrypts the data and decodes such data at the time of use through user authentication by inputting a password or the like.

When such an implementation is used, a data leak can happen to the outside of an organization with transmission of secret data using E-mail or the like. One way of deterring such a data leak is taken through employment of monitoring the E-mails with a mail server or the like on the intra-organization (corporation) network. However, if a recording medium (such as a floppy disk) containing recorded data travels with a person outside of the organization, it is impossible to deter such illegal action.

### SUMMARY OF THE INVENTION

The present invention has been proposed considering the problems explained above. Accordingly, it is an object of the present invention to provide a method to prevent illegal data leaks by copying the data to a recording medium and then carrying the medium to an outside organization, and to prevent illegal use of secret data recorded in the relevant medium and enable search and inspection of data after the data is copied and encrypted in the recording medium.

In preventing an unauthorized leak or use of data, one exemplary embodiment of the information management method of the present invention is accessing a authorization medium, when copying a data recorded in a first recording medium in an information processing apparatus to a second recording medium and executing the copying when an authorization permitting the copying from the first recording medium can be read from the authorization medium or refusing the copying when the authorization cannot be read. The authorization medium executes the copying process when the information permitting copy from the first recording medium can be read from the authorization medium or deters the copying process when the copy permitting information cannot be read out.

According to this exemplary embodiment, since it is possible that an administrator within the organization previously sets, to the authorization medium, the information permitting the copying of data to the second recording medium from the first recording medium and thereby to lend this authorization medium to only a person who is permitted to conduct the copying operation, the illegal copying of data by the third party can be deterred.

In this information management method, it is preferable that a copying destination range information for designating the destination range of copying is recorded to the authorization medium generated for information management, and the copying process is executed when the second recording medium is matched with the copying destination range information. But this copying process is deterred when the second recording medium is not matched with the medium class information. Moreover, if there is provided the structure that the data as the copying process object is encrypted and then recorded in the second recording medium, the data is encrypted. Automatically with the copying operation in the copying operation explained above, if the recording medium is handed over to the third party, illegal data use can be prevented.

Moreover, in view of preventing illegal use of data recorded in the recording medium, another exemplary embodiment of the information management method of the present invention is accessing, in a second recording medium, an information permitting the use of a data recorded in a first recording medium, when reading and using a data recorded in the first recording medium and permitting the use of the data when an apparatus can read the information from the second recording medium and refusing the use of data when the apparatus cannot read the information.

According to this exemplary embodiment, since it is possible that an administrator within the organization previously sets, to the second recording medium (for management), the information permitting the read and use of data recorded in the first recording medium to thereby loan the authorization medium to only a person who is permitted to conduct the copying operation, the illegal copying of data by the third party can be deterred.

It is preferable for protection of data to structure the information management method to provide a structure such that the data recorded in the first recording medium is encrypted, the encrypted data is copied to the authorization medium provided in the information processing apparatus and decoded when the information processing apparatus uses the encrypted data recorded in the authorization medium or the data processed based on the process using the decoded data is encrypted for the write-back process when the processed data is written back for the authorization medium. Thus, one aspect of the present invention is to allow various profiles, which will become apparent from the preferred embodiments and the additional explanation hereafter.

Further, in preventing an illegal use of a data in the above embodiment, various embodiments can also include a process that is recording a data application number information in the first recording medium and a data application maximum number in the authorization medium, reading, when using the data of the first recording medium, the data application number information and data application maximum number information, comparing the data application number information and data application maximum number information and permitting the use of the data and incrementing the data application number information by one when the data application number does not exceed the data application maximum number and refusing the use of the data when the data application number exceeds the data application maximum number.

In a further exemplary embodiment, an information management method can include setting, to a authorization medium, by a first information processing apparatus, an information permitting a copy of a data stored in a first recording medium provided in a second information processing apparatus to a second recording medium and copying, with the second information processing apparatus, the data stored on the first recording medium, to the second recording medium, when the information permitting a copy can be read from the authorization medium. Another exemplary embodiment includes having a first information processing apparatus set to a second recording medium an information permitting the use of a data recorded in a first recording medium with a second information apparatus when the data is read with the second information processing apparatus.

A further exemplary embodiment can include setting, using a first information processing apparatus, to a authorization medium, a copy permitting information of a data recorded in a first recording medium provided in a second information processing apparatus to a second recording medium and an information permitting a use of the data copied to the second recording medium by a third information processing apparatus, copying, using the second information processing apparatus, the data to the second recording medium from the first recording medium when the second information processing apparatus can read the copy permitting information from the authorization medium and enabling the third information processing apparatus to use the data recorded in the second recording medium when the third information processing apparatus can read the data application permitting information from the authorization medium.

A further exemplary embodiment can include copying a data recorded in a first recording medium provided in a first information processing apparatus to a second recording medium, writing back, using a second information processing apparatus, to the second recording medium, an updated data updated by processing the data recorded in the second recording medium, reading, using the first information processing apparatus, when executing the process to write back the data written back by the second recording medium to the first recording medium, an identification information of an original information processing apparatus in which the data existed from a authorization medium and permitting the write-back process of the data when the first information processing apparatus is identified and refusing the write-back process of data when a first information processing apparatus cannot be identified and/or the identification information cannot be read.

A further exemplary embodiment can be an electronic storage medium containing a program embodying an information management method including accessing a authorization medium when an instruction to copy a data recorded in a first recording medium provided in the information processing apparatus to a second recording medium is inputted and executing the instruction to copy when the apparatus can read an information permitting the copy from the first recording medium or the authorization medium and refusing the instruction to copy when the apparatus cannot read the copy permitting information.

A further exemplary embodiment can be an electronic storage medium containing a program embodying an information management method that includes accessing a authorization medium before reading and using a data recorded in a first recording medium and permitting the use of the data when the apparatus can read, from a authorization medium, an information permitting the use of data in the first recording medium or refusing the use of the data when the information processing apparatus cannot read the information permitting the use of data.

A further exemplary embodiment can be an electronic storage medium containing a program embodying an information management method that includes recording at least one process to a authorization medium, including a security information about permitting a copy of a data stored on a first recording medium inserted in a second information processing apparatus to a second recording medium when the information is read with the second information processing apparatus.

A further exemplary embodiment can be an electronic storage medium containing a program embodying an information management method, that includes recording at least one process to a authorization medium, including a security information for permitting a use of a data recorded on a first recording medium by a second information processing apparatus when the security information is read with the second information processing apparatus.

In various exemplary embodiments, the storage mediums mentioned can be at least one of a floppy disk, a compact disk, a digital video disk, a removable hard drive, a zip disk, an optical recording disk, an electronic memory device, an integrated circuit card, a proximity card, a data card, a optical recording card and an impression transfer card.

These, together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram for explaining the overall concept of the structure and processes according to preferred embodiments of the present invention;

FIG. 2 is a diagram showing the data recorded in the IC card in a preferred embodiment of the present invention;

FIG. 3 is a flowchart showing the IC card issuing process (procedure 1) in a preferred embodiment of the present invention;

FIG. 4 is a flowchart showing the copying and encryption process (procedure 2) of data in a preferred embodiment of the present invention;

FIG. 5 is a flowchart showing the process (procedure 3) for using the encrypted data by decoding thereof in a preferred embodiment of the present invention;

FIG. 6 is a flowchart showing the IC card return/inspection process (procedure 4) in a preferred embodiment of the present invention;

FIG. 7 is a flowchart showing the data returning process (procedure 5) in a preferred embodiment of the present invention; and

FIG. 8 is a diagram for explaining the summary of the processes in the procedures 2, 3, 5 according to a preferred embodiment of the present invention.

### DETAILED DESCRIPTION OF THE PREFERRED EMBODIMENTS

Various exemplary aspects and embodiments of the present invention will be explained with reference to the accompanying drawings. Various other exemplary embodiments will be obvious through the examples provided herein.

As used herein, a recording medium can be, for example, any one of a floppy disk, a compact disk, a digital video disk, a removable hard drive, a zip disk, an optical recording disk and an electronic memory device. Further, a copy destination class or range can be a type of electronic recording media. For example a hard drive or a network drive may be one class or range and floppy disks may be a second class or range. A data application number can be a unique number for identifying either a type of software, a specific software program or a specific copy of a software program.

Additional terms used herein include a data application validity term, which can be any time period where the use of data or software to access data is authorized. A right information can be any of authorization information, access rights, modification rights, or any other type of authorization as is now known or later devised.

Important or secret data of an organization is generally specified with an implementation rule and/or regulation so that it is used only for specified limited purposes within an organization. When someone requests to use the data outside the organization, a user can intentionally encrypt the data and allow the person to decode the data at the time of use through a user authentication.

If management is worried about a data leak to the outside of the organization via transmission of secret data using E-mail or the like, E-mails are monitored with a mail server or the like on the intra-organization (corporation) network. However, if a recording medium recording the data is copied by a person belonging to the relevant organization and is illegally carried to the outside of organization, it has been impossible to deter such illegal action.

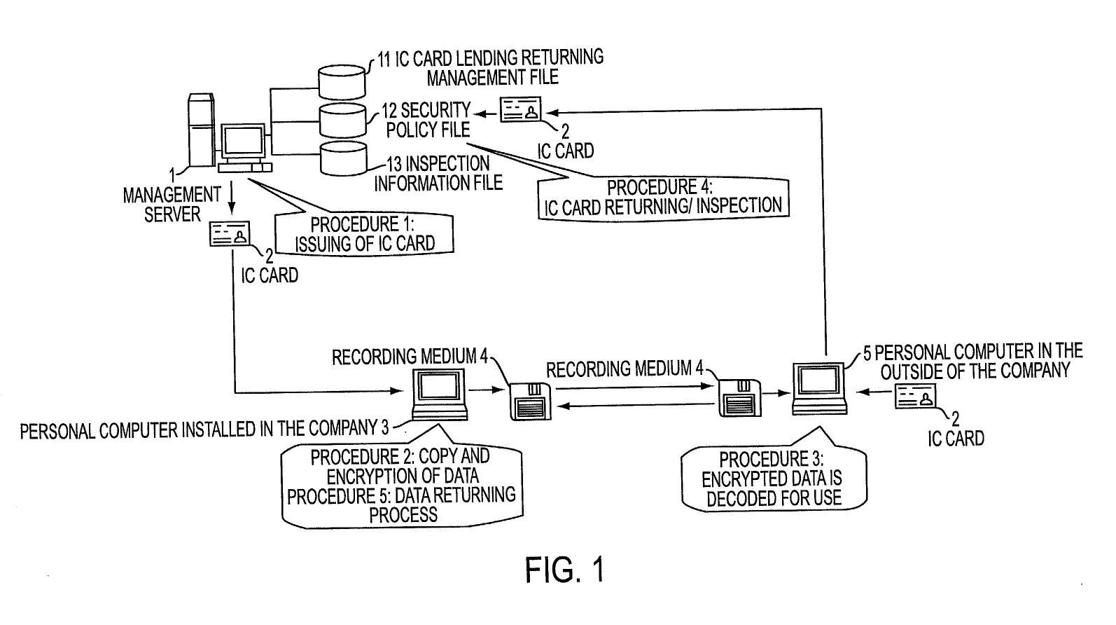

FIG. 1 is a diagram that explains an exemplary structure and concept used in an exemplary aspect of the present invention. The arrow marks show the flow of the process and possible movement of an IC card and a recording medium 4 and do not indicate the data transmission via the communication line.

As shown in FIG. 1, a management server 1 issues an IC card 2 (which is a recording medium for management) in which the security policy for dealing with the secret data is recorded (procedure 1). This management server 1 is manipulated by an administrator in charge within the company (organization).

The issued IC card 2 is then loaned to a data copying operator who is permitted to conduct the copying operation by the administrator. This data copying operator executes, when copying the “Intra-Office Only” data to the recording medium 4 other than the hard disc drive (HDD) from a personal computer provided within the company (organization), the copying operation and encryption of data based on the security policy recorded in the IC card 2 issued in the procedure 1 and thereby the executed processes are recorded in the IC card 2 (procedure 2).

In FIG. 1, a floppy disc is shown as an example of a recording medium 4, but the present invention is not limited thereto. Namely, removable recording mediums such as an external hard disk drive, MO, or ZIP drive other than the built-in hard disk drive and the copying process to a network drive are also considered part of the invention. The process is further explained in the procedure 2.

In the case where the data recorded in this recording medium 4 is used in a personal computer 5 other than the computer 3 in which the original data is recorded (for example, a mobile computer carried to the outside of the company or a computer provided in a branch office or the like), copy and use of data are possible based on the security policy recorded in the IC card 2. A record of the processes executed is also recorded in the IC card 2 (procedure 3). In FIG. 1, the data copying operator who has executed the procedure 2 is capable of carrying the IC card 2 to the outside of the organization, for example, and then using this IC card 2 there. Moreover, the data copying operator (or an administrator who has once received the IC card 2 returned from the data copying operator) is capable of lending this IC card 2 to the other data user.

The IC card 2 in which the processes of the procedures 1 and 2 are recorded is returned to the management server 1 for the purpose of inspection and this IC card 2 is inspected by the administrator (procedure 4).

When it is requested that the file used in the procedure 3 is written back to the computer 3 where the original file has existed, the data returning process (procedure 5) is executed. The management server 1 comprises an IC card lending-returning management file 11 in which the information regarding the lending of IC card in the procedure 1 explained later and the information regarding the return of IC card in the procedure 4 are recorded, a security policy information file 12 which is referred when the IC card 2 is issued in the procedure 1 and an inspection information recording file 13 for reading and recording the inspection information from the IC card when the IC card is returned in the procedure 4. Moreover, the management server 1 is also provided with a card slot for the read/write access for the IC card 2 (not shown in the figure).

The personal computers 3, 5 are respectively provided with a drive for executing the read/write access to the recording medium 4 and a card slot (not shown in the figure) for executing the read/write access to the IC card 2. These drive and card slots also include the structure which is not built in the server or computer and can be realized with the external installation.

The process program for executing the procedures 1 and 4 is installed in the management server, while the process program for executing the procedures 2 and 5 is installed in the personal computer 3 and the process program for executing the procedure 3 is installed in the personal computer 5, respectively.

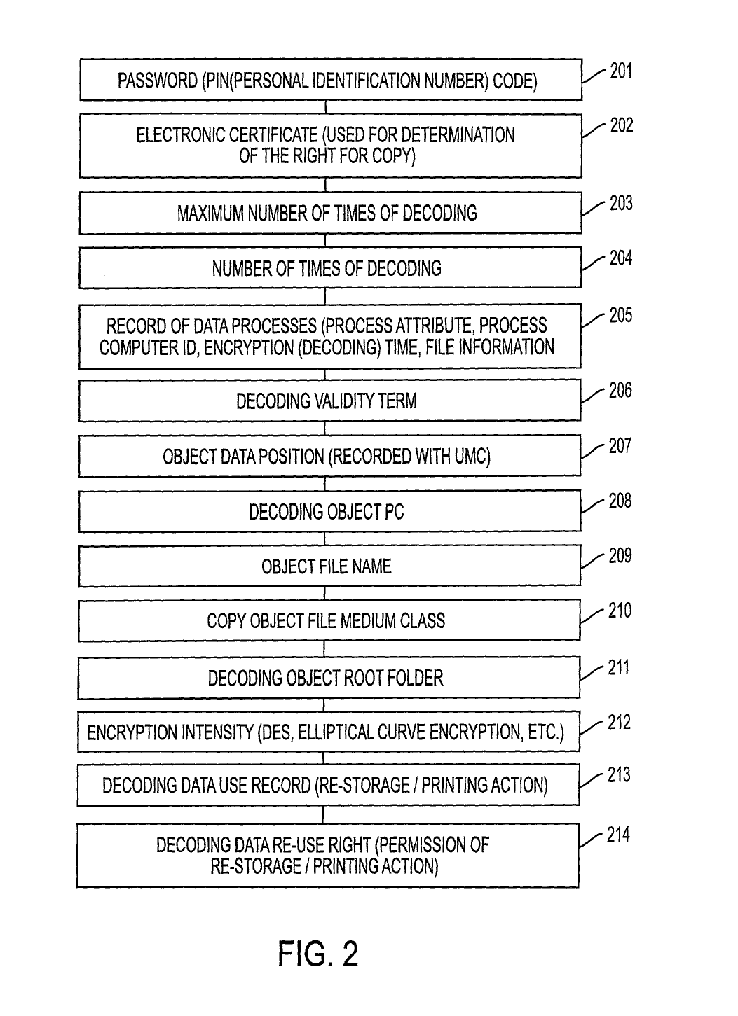

FIG. 2 is a diagram showing the attributes of the information recorded in the IC card 2. In this figure, the item number 205 Record of Data Processes is the region for recording the processes (process attribute, ID of the apparatus executing the process, processing time, or the like) when the process is executed with a personal computer in the procedures 2, 3, 5 explained later. The management server sets the other regions in the above procedure 1.

The reason why an IC card is used as a medium for data management in this embodiment is that an IC card has very excellent characteristics as a security medium, does not have fragileness which can be found in an electronic medium of the related art and can protect perfectly the data written inside thereof.

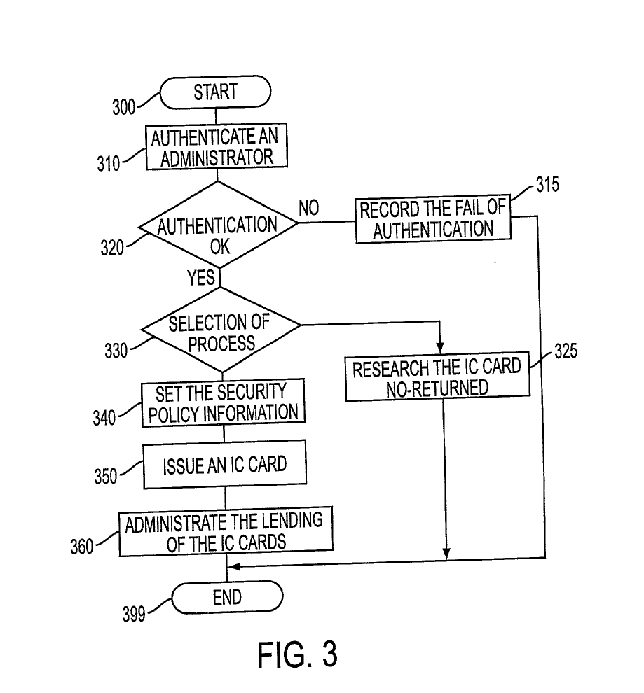

Next, using the flowcharts of FIG. 3 through FIG. 7, the practical processing operations of procedure 1 through procedure 4 in the system shown in FIG. 1 will be explained.

FIG. 3 is a flowchart showing an exemplary process (Procedure 1) of an IC card issuing process. The process begins at start 300. The management server 1 first authenticates an administrator at 310, i.e., whether a server operator is a justified administrator or not. If authentication OK at 320 fails, this information is recorded at 315 to the inspection information file 13.

When an operator is authenticated as the justified administrator at 320, the IC card issuing process or IC card non-return inspection process is executed at 325 depending on the selection input for the process to be executed at 330. When the IC card issuing process is selected at 350, the security policy information is first set at. As this setting process, the condition information such as importance degree of object data and attribute (position, or the like) of an object person for execution of the procedures 2, 3 explained later is inputted with an administrator and a data use limitation information or the like corresponding to the input condition information is edited with reference to the setting of security policy information file 12 at 340. As explained above, the various information pieces shown in FIG. 2 are written into the IC card 2.

The destination of lending, date of lending, date of return of the IC card 2 are recorded in the IC card lending-returning management file 11. When the IC card no-return inspection process is selected at 325, the IC card lending-returning management file 11 is accessed to check whether the IC card 2 having passed the return date exists or not. If the IC card having passed the return date is detected, the destination of lending is read and an owner of this IC card is recorded to the inspection information file 13 as an offender against the security policy. Moreover, a warning message is notified as required to the offender. The process ends at end 399.

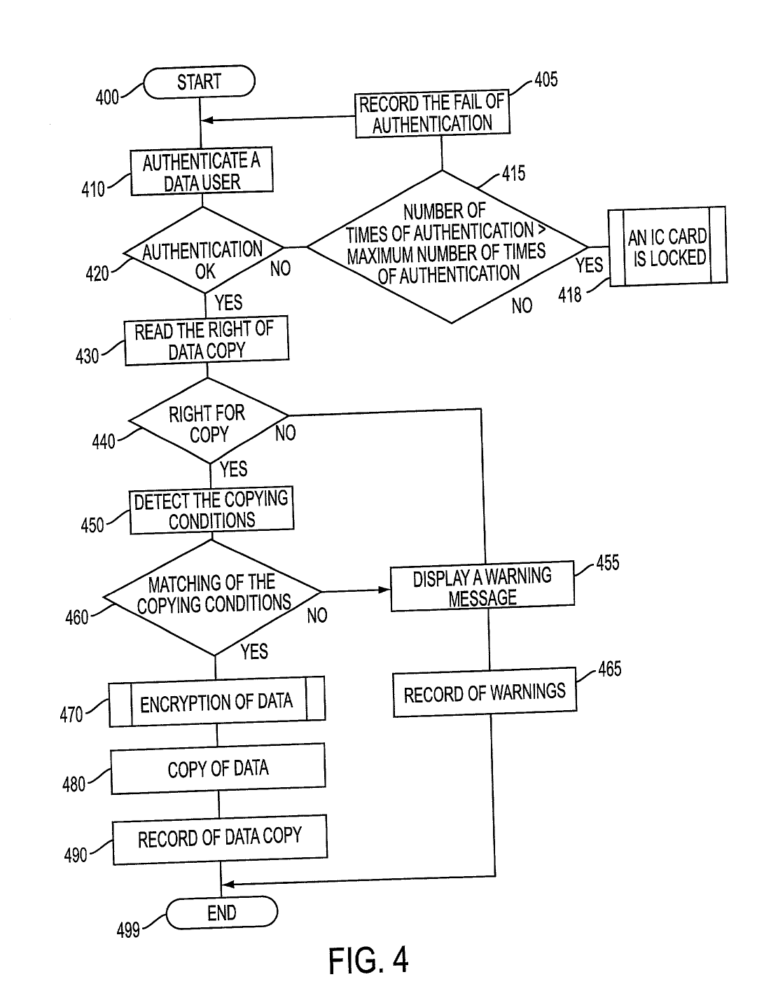

FIG. 4 is a flowchart showing a second exemplary (procedure 2) data copy and encryption process. The process begins at start 400. A personal computer 3 of the company to which the data is to be protected and a software to execute the processes, are installed. The personal computer 3 authenticates an operator of this computer as a data user who can execute the data process or not using the IC card 2. This authentication administrator at 410 is conducted through collation with the password 201 written in the IC card 2.

If authentication administrator fails at 420, it is determined at 415 whether the number of times of authentication has exceeded the maximum number of times of authentication administrator recorded in the IC card or not. When exceeded, the IC card is locked at 418 disabling the use. When not exceeded, failure of authentication administrator is recorded at 405 and authentication administrator is accepted again at 410. Such authentication process is executed with the function of an ordinary IC card.

When authentication is executed, whether an operator has the right for copying the data or not is authenticated from an electronic certificate 202 recorded in the IC card 2. If the operator does not have the right for copying the data at 450, a warning message is displayed at 455 and the warning information is recorded at 465 to a data process recording region 205.

After this check is completed, the manipulation is conducted to copy the data located in the position 207 of the object data. The file to be copied is matched with the object file name 209. The medium in the drive of the destination of copy is matched with copy object medium class 210 in the IC card 2. (If copy of the object file is attempted without using the IC card, the process program stops the copying process itself.) If these conditions are not matched, a warning display is executed and a warning record is recorded at 465 in the data processing region 205.

When the conditions are matched, the data of the copying sources are read and are then written into the medium 480 as the copy destination. The data is encrypted using the encryption process and an encryption key (not shown) recorded in the IC card. An encryption/decoding program at 470 may be provided in the side of the IC card 2 or may be executed with the process program installed in the computer. When these processes are completed, a record of data copy is recorded at 490 in the data processing region 205. The process ends at 499.

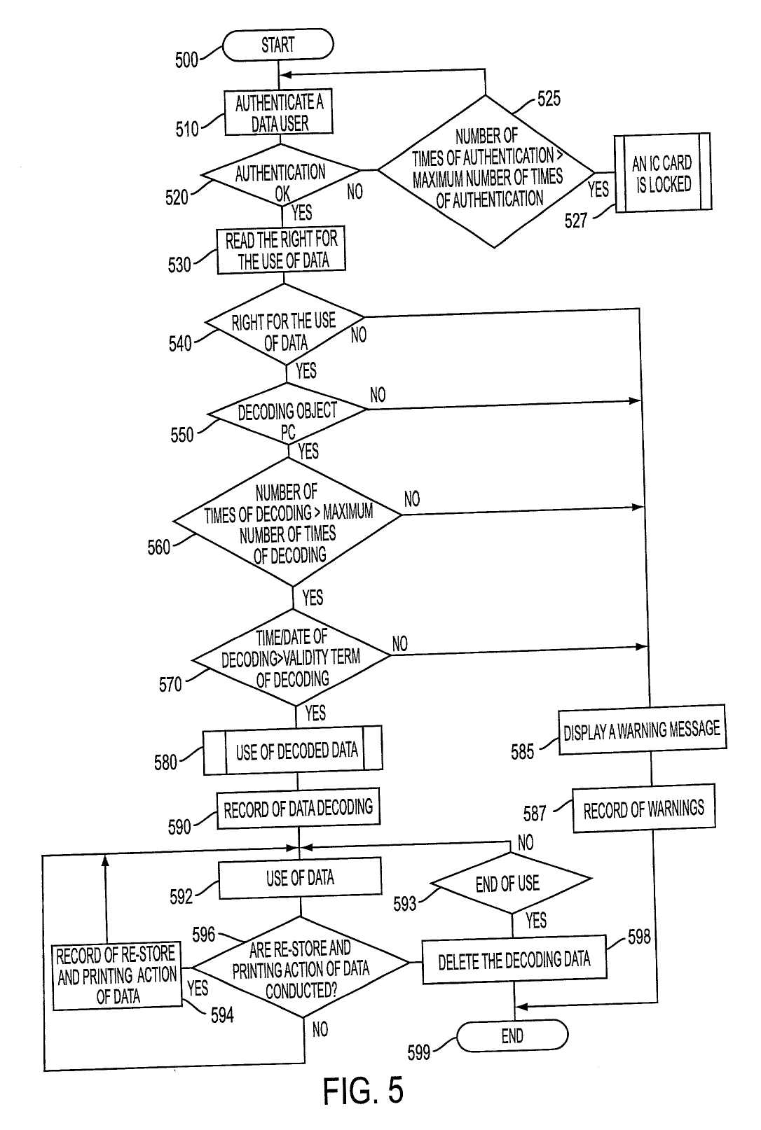

FIG. 5 is a flowchart showing another exemplary embodiment of the Encrypted data decoding/application process (procedure 3). The process begins at start 500. The process for decoding and using the encrypted data copied in the recording medium as explained above with a personal computer 5 different from that as the source of copy will be explained. When using such recording medium in this embodiment of the present invention, the IC card 2 must be set.

First, whether a data user is qualified to execute the data process using the IC card 2 or not is authenticated at 510. This authentication administrator is conducted at 520 through collation with the password 201 written in the IC card 2. If authentication administrator fails, at 525 when the number of times of authentication has exceeded the maximum number of times of authentication recorded in the IC card, the IC card is locked at 527, disabling the use. When not exceeded, failure of authentication is recorded.

When authentication is conducted, at 530 whether an operator has the right for copying the data or not is determined from the electronic certificate 202 recorded in the IC card 2. If an operator does not have the right for copying the data, a warning message is displayed at 585 and warning information is recorded at 587 to the data process recording region 205.

When the operator has the right for copying the data at 540, a decoding object PC 208 is read out to check whether the relevant personal computer is the decoding object PC or not at 550. This check may be conducted by previously giving a unique ID to the process program to be installed and then checking the match or by checking the ID for the hardware such as computer and drive.

When the process object PC is confirmed, the maximum number of times of decoding 203 and number of times of decoding 204 recorded in the IC card are read out and at 560 it is checked whether the number of times of decoding reaches the maximum number of times of decoding or not. Moreover, the date of decoding (the current date of system) is compared at 570 with the term of validity for decoding 206 to check whether the valid term of decoding is expired or not.

When a PC is found to be different than the process object PC with this check, at 560 if the decoding data has exceeded the permitted maximum number of times of decoding and the term of the decoding, the decoding process is not permitted and a warning message is displayed at 585 and a warning record is written in the data process recording region 205 at 587.

When the decoding data does not reach the maximum number of times of decoding and within the term of decoding, a decoding object root folder 211 is read out and the file read out from the recording medium 4 is copied to the relevant root folder under the encrypted condition.

When the application software reads and accesses the copied and encrypted file at 580, the decoding program uses this access to decode the data for use by the application software. Moreover, when the access is made to write the data processed with the application software to the file, the encryption program uses this access for encryption of data and writes the data to the file. Here, it is also possible to form the structure that this decoding program can be installed to a personal computer for execution like the encryption program even if the IC card 2 is not present. When the decoding process is executed, its record is recorded in the data process recording region 205 and the number of times of decoding 204 is incremented by one.

Here, data can be used 592 with the application software installed in the personal computer 5. In this case, when the input is conducted to instruct the re-storage and printing of data, the right for using the data at 540 read out previously is checked to check whether an operator of the computer 5 has the right for re-storage and printing of data or not at 596. When the operator has the right to use the data, re-storage and printing processes are executed at 594. When use of data is to be completed based on the application software 593, traces including the job files are erased 598 perfectly not to leave the decoded data in the hard disc of the computer 5. The process ends at end 599.

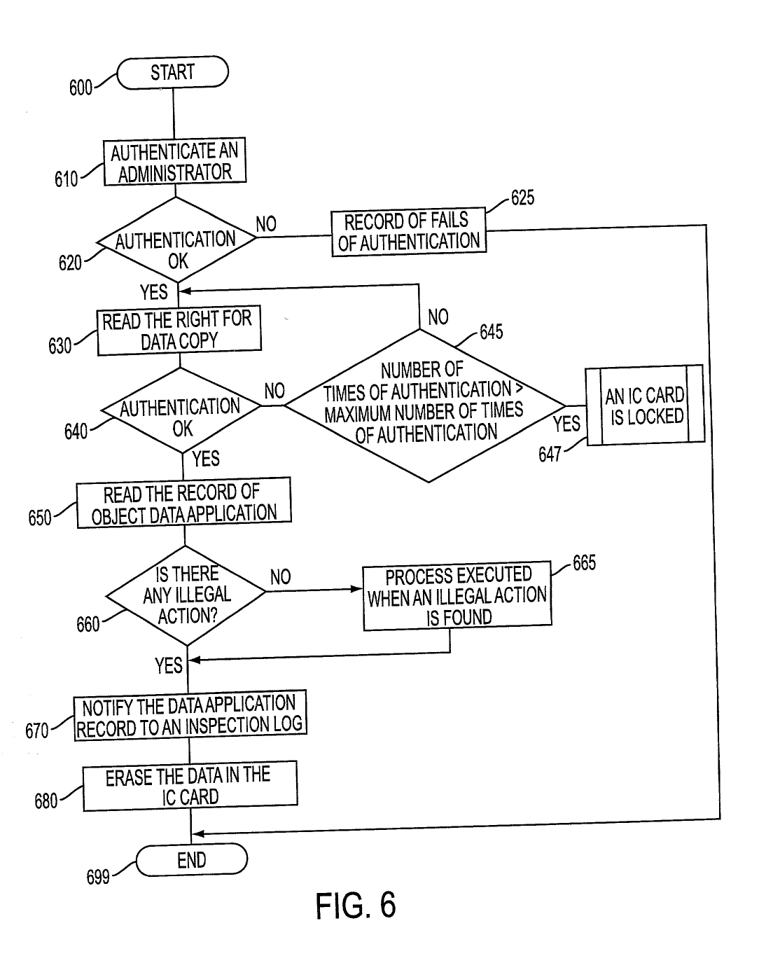

FIG. 6 is a flowchart showing an exemplary example of (the procedure 4) IC card return/inspection process flow. The process begins at start 600. The management server 1 requests to authenticate an administrator at 610 and determines whether an operator of the server is a justified administrator or not at 620. If authentication of the administrator fails, this information is recorded in the inspection information file 13 at 625. When the operator is authenticated as the justified administrator at 640, manipulation of the IC card 2 set to the card slot is authenticated at 630 and when the number of times of authentication administrator has exceeded the maximum number of times of authentication specified in the IC card at 645, the IC card is locked at 647.

When the authentication administrator is completed successfully at 620, the process record recorded in the data process recording region 205 of the IC card 2 is read out at 650 to check at 660 whether an action offending against the content recorded in the IC card 2 or not (actions to which a warning is issued by the system) is recorded. When an offending action is detected, the process for handling an offending action, which is preset in the system (for example, printing of a list of offending actions) is executed at 665.

Moreover, the record of process recorded at 670 in the data process recording region 205 is copied to the inspection information file 13 and when this process is completed, the IC card itself is initialized and the internal data is erased at 680. The process ends at 699.

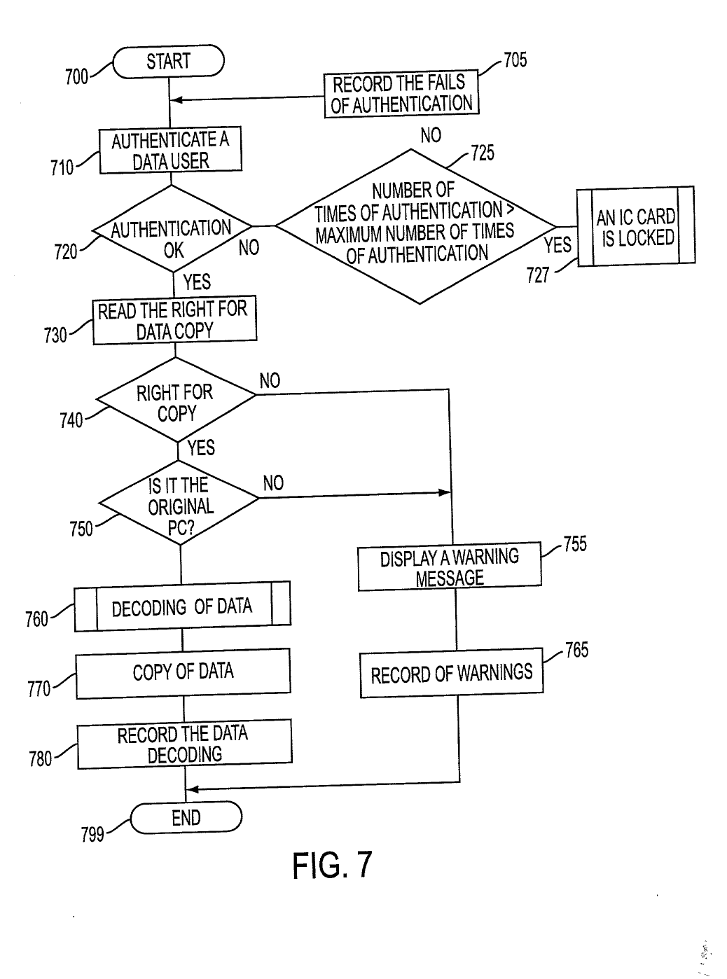

FIG. 7 is a flowchart showing an exemplary (procedure 5) process for returning the data. The process for writing back, to the computer, the file carried to the outside as a recording medium 4 after the process at the branch office or the like will now be explained below. The process begins at start 700.

Whether a data user is qualified to execute the data using the IC card 2 or not is authenticated at 710. When the authentication administrator at 720 fails, a record of defective authentication is written at 705 every time into the data process recording region 205 of the IC card 2. At 725, when the number of times of authentication has exceeded the maximum number of times of authentication recorded in the IC card, the IC card is locked at 727, disabling the use thereof.

When administrator authentication is completed successfully at 720, the right of an operator for copying the data is checked at 730 by reading the electronic certificate 202. When the right for copying the data is confirmed at 740, at 750 the object data position 207 is read to check whether the destination of copy (computer 2 to which the IC card 2 is set) is the computer in which the object data exists or not.

If these checks fail, a warning message is displayed at 755 and a record of warning is recorded at 765 to the data process recording region 205. When the check is completed successfully, a file is decoded at 760 and copied at 770 to write a record of copy at 780 to the data process recording region 205. The process ends at 799.

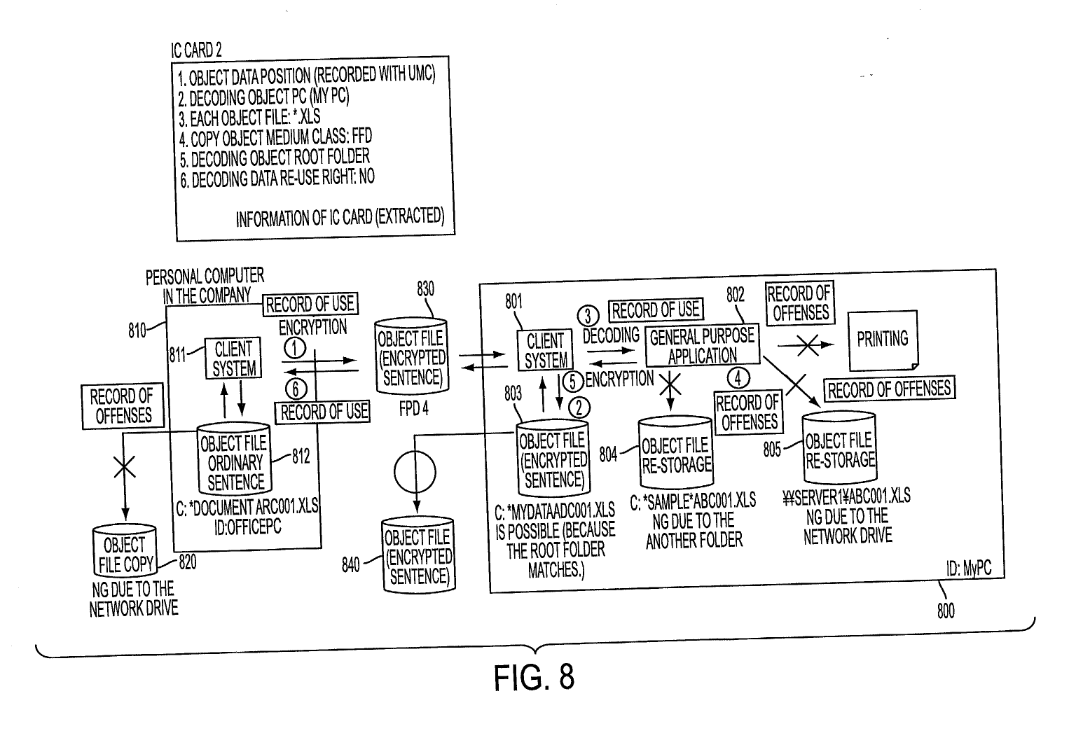

The processes in each procedure executed in the management server 1 or personal computers 3, 5 have been explained depending on the preferred embodiments. Moreover, an outline of the processes in the procedures 2, 3 and 5 will be explained below using an example of data recorded in the IC card with reference to FIG. 8.

FIG. 8 shows an exemplary embodiment of procedures 2, 3 and 5. The part given the sign o can be processed and the part given the sign x cannot be processed. Moreover, “Record of Use” and “Record of Offense” are respectively recorded to the data process recording region 205 of the IC card 2.

In the case where the data is extracted to FPD4 as a medium other than the built-in hard disk drive from a computer 3 (ID: OFFICEPC) in which the object data 207 “ABCOOI.XLS” is stored, matching with the copy object medium class 210 in the IC card is inspected. When matching with the copy object medium class is detected and matching of object file name with “*.XLS” is detected, data extraction is carried out. Moreover, since the copy object medium class 210 is defined as a floppy disc drive, when the medium of the copy object destination is a floppy disc drive, the data is copied. When the copy object destination is a network drive which is not specified in the copy object medium class 210, the copy is prohibited.

When copying the data, the encrypted data is written into the floppy disc drive. Since the PC using data (ID: MyPC) is matched with the decoding object PC name 208 within the IC card 2 (MyPC), the data copied to the “C:\MyData” described in the decoding object root folder 211 under the encrypted condition.

When reading the object file in which the general purpose application is encrypted, the data is decoded. In this example, since the information suggesting no right is set in the decoding data re-use right 214, re-storage and printing of the encrypted data in the general purpose application are prohibited. Here, the encrypted file can be copied to the other folder, but it is impossible to read in direct the data because of encryption and moreover since the folder is the one other than the decoding object root folder 211, decoding is impossible even when the IC card 2 is used.

The data can be stored in the decoding object folder using the same file name or the other file name by editing the data. In this case, the data is encrypted again. In the case where the object file is returned to the original PC after the use thereof, the PC is checked whether it is the PC (ID: OFFICEPC) where the object data exists or not. When the check result is OK, the data is decoded and then returned.

As explained above, when the “Intra-Organization Only” data is copied to a recording medium in view of carrying the same data outside of the organization, the information to permit the copy of data is required. The information can be on a recording medium (IC card or the like), which is different from the recording medium explained above, but of similar nature. Therefore, executing the management of the recording media (including such copy permitting information) can prevent unauthorized leaks of the data.

Moreover, when the data of a recording medium is to be used, a recording medium having recorded the information for permitting the use of data, which is different from above recording medium is also required. Therefore, unauthorized use and copy of the data can be deterred with execution of the management of this recording medium.

Moreover, when copy and use of data is executed or if implementation fails due to the illegal actions or the like, a record of such execution and implementation is generated and thereby traces and inspections for use of data and illegal use of data (attempted) or the like can be enabled.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An information management method, comprising:
accessing an authorization medium, when copying a data recorded in a first recording medium in an information processing apparatus to a second recording medium; and
executing the copying when an authorization permitting the copying from the first recording medium can be read from the authorization medium or refusing the copying when the authorization cannot be read.

2. An information management method according to claim 1, further comprising:
recording, to the authorization medium, a copy destination class information that designates what the second recording medium of the copying is, such that the copying is executed when the copy destination class information matches a medium class information and the copying is refused when the copy destination class information does not match with the medium class information.

3. An information management method according to claim 1, further comprising:
encrypting the data creating an encrypted data and recording the encrypted data to the second recording medium.

4. An information management method according to claim 1, further comprising:
recording, in the authorization medium, a record of processes executed whenever executing the copying and/or refusing the copying.

5. An information management method according to claim 1, wherein the authorization medium is at least one of an integrated circuit card, a proximity card, a data card, a optical recording card and an impression transfer card.

6. An information management method according to claim 1, wherein the second recording medium is at least one of a floppy disk, a compact disk, a digital video disk, a removable hard drive, a zip disk, an optical recording disk and an electronic memory device.

7. An information management method according to claim 1, wherein the first recording medium is at least one of a hard drive, a network drive, a floppy disk, a compact disk, a digital video disk, a non-removable hard drive, a zip disk, an optical recording disk and an electronic memory device.

8. An information management method according to claim 1, further comprising:
authenticating the authorization using at least one of a password and the authorization medium, wherein the copying is refused if the authorization is not properly authenticated.

9. An information management method according to claim 1, further comprising:
comparing the authorization to an expected authorization using at least one of a password and the authorization medium, wherein the copying is refused if the authorization is not the expected authorization.

10. An information management method, comprising:
accessing, in a authorization medium, an information permitting the use of a data recorded in a first recording medium, when reading and using a data recorded in the first recording medium; and
permitting the use of the data when a first processing apparatus can read the information from the authorization medium and refusing the use of data when the first processing apparatus cannot read the information.

11. An information management method according to claim 10, further comprising:
encrypting the data recorded in the first recording medium, when the data is copied to a authorization medium creating an encrypted data;
decoding the encrypted data, when using the encrypted data recorded in the authorization medium, creating a processed data; and
re-encrypting, for a write-back process, the processed data when writing back the processed data to the authorization medium.

12. An information management method according to claim 11, further comprising:
encrypting the data, recorded in the first recording medium, when the data is copied to a authorization medium creating encrypted data;
decoding the encrypted data, when using the encrypted data recorded in the authorization medium, creating a processed data; and
re-encrypting, for a write-back process, the processed data when writing back the processed data to the authorization medium.

13. An information management method according to claim 10, further comprising:
identifying a software using the data and/or an ID information on the authorization medium; and
reading the ID information and permitting the use of the data when the ID information and/or the software is determined to be capable of using the data and refusing the use of the data when the ID information and/or the software are determined to be incapable of using the data.

14. An information management method according to claim 11, further comprising:
recording a data application number information in the first recording medium and a data application maximum number in the authorization medium;
reading, when using the data of the first recording medium, the data application number information and data application maximum number information;
comparing the data application number information and data application maximum number information; and
permitting the use of the data and incrementing the data application number information by one when the data application number does not exceed the data application maximum number and refusing the use of the data when the data application number exceeds the data application maximum number.

15. An information management method according to claim 11, further comprising:
recording a data application validity term information in the authorization medium;
determining, when using the data recorded in the first recording medium, whether a current time is within a data application validity term by comparing the data application validity term information with a current date/time information; and
permitting the use of the data when the current date/time information is within the validity term and refusing the use of the data when the current date/time information exceeds the validity term.

16. An information management method according to claim 10, further comprising:
recording, in the authorization medium, a right information indicating a right of an object operator to whom a particular process for the data is permitted;
authenticating, when executing the particular process, an operator based on the right information; and
executing the particular process when the authentication is executed or refusing the particular process when the authentication fails.

17. An information management method according to claim 16, wherein the particular process is a process to print the data.

18. An information management method according to claim 10, further comprising:
recording, in the authorization medium, a copy destination range information that designates a destination of a copy;
determining whether a authorization medium matches with the copy destination range information recorded; and
permitting copying when matching is attained or authenticating the right of an operator when the matching is not attained and permits, only when the authentication is executed, the copying to the destination of copying which does not match with the copy destination range information.

19. An information management method according to claim 11, further comprising:
recording, in the authorization medium, a copy destination range information that designates a destination of a copy;
determining whether a authorization medium matches with the copy destination range information recorded; and
permitting copying when matching is attained or authenticating the right of an operator when the matching is not attained and permits, only when the authentication is executed, the copying to the destination of copying which does not match with the copy destination range information.

20. An information management method according to claim 10, wherein the information processing apparatus records a record of processes executed when the apparatus has executed the process to use the data and/or refused the process to use the data.

21. An information management method according to claim 10, wherein the first information processing apparatus sets, to the authorization medium, the information permitting the copy of the data stored in the first recording medium provided in the second information processing apparatus to the authorization medium when such information is read with the second information processing apparatus.

22. An information management method according to claim 10, wherein the authorization medium is at least one of an integrated circuit card, a proximity card, a data card, a optical recording card and an impression transfer card.

23. An information management method according to claim 10, wherein the authorization medium is at least one of a floppy disk, a compact disk, a digital video disk, a removable hard drive, a zip disk, an optical recording disk and an electronic memory device.

24. An information management method according to claim 10, wherein the first recording medium is at least one of a hard drive, a network drive, a floppy disk, a compact disk, a digital video disk, a non-removable hard drive, a zip disk, an optical recording disk and an electronic memory device.

25. An information management method according to claim 10, further comprising:
authenticating the information using at least one of a password and the authorization medium, wherein the copying is refused if the information is not properly authenticated.

26. An information management method according to claim 1, further comprising:
comparing the information to an expected information using at least one of a password and the authorization medium, wherein the copying is refused if the information is not the expected information.

27. An information management method, comprising:
setting, to a authorization medium, by a first information processing apparatus, an information permitting a copy of a data stored in a first recording medium provided in a second information processing apparatus to a second recording medium; and
copying, with the second information processing apparatus, the data stored on the first recording medium, to the second recording medium, when the information permitting a copy can be read from the authorization medium.

28. An information management method according to claim 27, wherein the authorization medium is at least one of an integrated circuit card, a proximity card, a data card, a optical recording card and an impression transfer card.

29. An information management method according to claim 27, wherein the second recording medium is at least one of a floppy disk, a compact disk, a digital video disk, a removable hard drive, a zip disk, an optical recording disk and an electronic memory device.

30. An information management method according to claim 27, wherein the first recording medium is at least one of a hard drive, a network drive, a floppy disk, a compact disk, a digital video disk, a non-removable hard drive, a zip disk, an optical recording disk and an electronic memory device.

31. An information management method according to claim 27, wherein the first information processing apparatus records, when the information is set to the authorization medium, a record of the setting processes to a fourth recording medium provided in the first processing apparatus.

32. An information management method according to claim 31, wherein the fourth recording medium is at least one of a hard drive, a network drive, a floppy disk, a compact disk, a digital video disk, a non-removable hard drive, a zip disk, an optical recording disk and an electronic memory device.

33. An information management method according to claim 27, wherein a record of the processes executed with the second information processing apparatus is recorded in the authorization medium and the first information processing apparatus reads the record of processes recorded in the authorization medium and records this record in a fourth recording medium provided in the first processing apparatus.

34. An information management method according to claim 33, wherein the fourth recording medium is at least one of a hard drive, a network drive, a floppy disk, a compact disk, a digital video disk, a non-removable hard drive, a zip disk, an optical recording disk and an electronic memory device.

35. An information management method according to claim 27, further comprising:
authenticating the information using at least one of a password and the authorization medium, wherein the copying is refused if the information is not properly authenticated.

36. An information management method according to claim 27, further comprising:
comparing the information to an expected information using at least one of a password and the authorization medium, wherein the copying is refused if the information is not the expected information.

37. An information management method, comprising:
having a first information processing apparatus set to a second recording medium an information permitting the use of a data recorded in a first recording medium with a second information apparatus when the data is read with the second information processing apparatus.

38. An information management method according to claim 37, wherein the first information processing apparatus sets, to the second recording medium, a number of times of permission by the second information processing apparatus for the use of the data recorded in the first recording medium.

39. An information management method according to claim 37, wherein the first information processing apparatus sets, to the second recording medium, a validity term information for permitting, by the second information processing apparatus, the use of data recorded in the first recording medium.

40. An information management method according to claim 37, wherein the first information processing apparatus records, when an information is set to the second recording medium, a record of the setting processes to the authorization medium provided in the first information processing apparatus.

41. An information management method according to claim 37, wherein a record of the processes executed with the second information processing apparatus is recorded to the second recording medium and the first information processing apparatus reads the record of the processes recorded in the second recording medium and then records this record to the authorization medium provided in the first information processing apparatus.

42. An information management method according to claim 37, wherein the second recording medium is at least one of an integrated circuit card, a proximity card, a data card, a optical recording card and an impression transfer card.

43. An information management method according to claim 37, wherein the first recording medium is at least one of a hard drive, a network drive, a floppy disk, a compact disk, a digital video disk, a non-removable hard drive, a zip disk, an optical recording disk and an electronic memory device.

44. An information management method according to claim 37, further comprising:
authenticating the information using at least one of a password and the authorization medium, wherein the copying is refused if the information is not properly authenticated.

45. An information management method according to claim 37, further comprising:
comparing the information to an expected information using at least one of a password and the authorization medium, wherein the copying is refused if the information is not the expected information.

46. An information management method, comprising:
setting, using a first information processing apparatus, to an authorization medium, a copy permitting information of a data recorded in a first recording medium provided in a second information processing apparatus to a second recording medium and an information permitting a use of the data copied to the second recording medium by a third information processing apparatus;
copying, using the second information processing apparatus, the data to the second recording medium from the first recording medium when the second information processing apparatus can read the copy permitting information from the authorization medium; and
enabling the third information processing apparatus to use the data recorded in the second recording medium when the third information processing apparatus can read the data application permitting information from the authorization medium.

47. An information management method according to claim 46, wherein the authorization medium is at least one of an integrated circuit card, a proximity card, a data card, an optical recording card and an impression transfer card.

48. An information management method according to claim 46, wherein the second recording medium is at least one of a floppy disk, a compact disk, a digital video disk, a removable hard drive, a zip disk, an optical recording disk and an electronic memory device.

49. An information management method according to claim 46, wherein the first recording medium is at least one of a hard drive, a network drive, a floppy disk, a compact disk, a digital video disk, a non-removable hard drive, a zip disk, an optical recording disk and an electronic memory device.

50. An information management method according to claim 46, further comprising:
authenticating the copy permitting information using at least one of a password and the authorization medium, wherein the copying is refused if the copy permitting information is not properly authenticated.

51. An information management method according to claim 46, further comprising:
comparing the copy permitting information to an expected copy permitting information using at least one of a password and the authorization medium, wherein the copying is refused if the copy permitting information is not the expected copy permitting information.

52. An information management method, comprising:
copying a data recorded in a first recording medium provided in a first information processing apparatus to a second recording medium;
writing back, using a second information processing apparatus, to the second recording medium, an updated data updated by processing the data recorded in the second recording medium;
reading, using the first information processing apparatus, when executing the process to write back the data written back by the second recording medium to the first recording medium, an identification information of an original information processing apparatus in which the data existed from a authorization medium; and
permitting the write-back process of the data when the first information processing apparatus is identified and refusing the write-back process of data when a first information processing apparatus cannot be identified and/or the identification information cannot be read.

53. An information management method according to claim 52, wherein the authorization medium is at least one of an integrated circuit card, a proximity card, a data card, a optical recording card and an impression transfer card.

54. An information management method according to claim 52, wherein the second recording medium is at least one of a floppy disk, a compact disk, a digital video disk, a removable hard drive, a zip disk, an optical recording disk and an electronic memory device.

55. An information management method according to claim 52, wherein the first recording medium is at least one of a hard drive, a network drive, a floppy disk, a compact disk, a digital video disk, a non-removable hard drive, a zip disk, an optical recording disk and an electronic memory device.

56. An information management method according to claim 52, further comprising:
authenticating the identification information using at least one of a password and the authorization medium, wherein the copying is refused if the identification information is not properly authenticated.

57. An information management method according to claim 52, further comprising:
comparing the identification information to an expected identification information using at least one of a password and the authorization medium, wherein the copying is refused if the identification information is not the expected identification information.

58. An electronic storage medium containing a program embodying an information management method, comprising:
accessing a authorization medium when an instruction to copy a data recorded in a first recording medium provided in the information processing apparatus to a second recording medium is inputted; and
executing the instruction to copy when the apparatus can read a copy permitting information permitting the copy from the first recording medium or the authorization medium and refusing the instruction to copy when the apparatus cannot read the copy permitting information.

59. An electronic storage medium according to claim 58, wherein the authorization medium is at least one of an integrated circuit card, a proximity card, a data card, a optical recording card and an impression transfer card.

60. An electronic storage medium according to claim 58, wherein the second recording medium is at least one of a floppy disk, a compact disk, a digital video disk, a removable hard drive, a zip disk, an optical recording disk and an electronic memory device.

61. An electronic storage medium according to claim 58, wherein the first recording medium is at least one of a hard drive, a network drive, a floppy disk, a compact disk, a digital video disk, a non-removable hard drive, a zip disk, an optical recording disk and an electronic memory device.

62. An information management method according to claim 58, further comprising:
authenticating the copy permitting information using at least one of a password and the authorization medium, wherein the copying is refused if the copy permitting information is not properly authenticated.

63. An information management method according to claim 58, further comprising:
comparing the copy permitting information to an expected copy permitting information using at least one of a password and the authorization medium, wherein the copying is refused if the copy permitting information is not the expected copy permitting information.

64. An electronic storage medium containing a program embodying an information management method, comprising:
accessing a authorization medium before reading and using a data recorded in a first recording medium; and
permitting the use of the data when the apparatus can read, from the authorization medium, an information permitting the use of data in the first recording medium or refusing the use of the data when the information processing apparatus cannot read the information permitting the use of data.

65. An electronic storage medium according to claim 64, wherein the authorization medium is at least one of an integrated circuit card, a proximity card, a data card, an optical recording card and an impression transfer card.

66. An electronic storage medium according to claim 64, wherein the first recording medium is at least one of a hard drive, a network drive, a floppy disk, a compact disk, a digital video disk, a non-removable hard drive, a zip disk, an optical recording disk and an electronic memory device.

67. An information management method according to claim 64, further comprising:
authenticating the information permitting the use of data using at least one of a password and the authorization medium, wherein the copying is refused if the information permitting the use of data is not properly authenticated.

68. An information management method according to claim 64, further comprising:
comparing the information permitting the use of data to an expected information permitting the use of data using at least one of a password and the authorization medium, wherein the copying is refused if the information permitting the use of data is not the expected information permitting the use of data.

69. An electronic storage medium containing a program embodying an information management method, comprising:
recording at least one process to a authorization medium, including a security information about permitting a copy of a data stored on a first recording medium inserted in a second information processing apparatus to a second recording medium when the information is read with the second information processing apparatus.

70. An electronic storage medium according to claim 69, wherein the authorization medium is at least one of an integrated circuit card, a proximity card, a data card, a optical recording card and an impression transfer card.

71. An electronic storage medium according to claim 69, wherein the second recording medium is at least one of a floppy disk, a compact disk, a digital video disk, a removable hard drive, a zip disk, an optical recording disk and an electronic memory device.

72. An electronic storage medium according to claim 69, wherein the first recording medium is at least one of a hard drive, a network drive, a floppy disk, a compact disk, a digital video disk, a non-removable hard drive, a zip disk, an optical recording disk and an electronic memory device.

73. An electronic storage medium containing a program embodying an information management method, comprising:
recording at least one process to a authorization medium, including a security information for permitting a use of a data recorded on a first recording medium by a second information processing apparatus when the security information is read with the second information processing apparatus.

74. An electronic storage medium according to claim 73, wherein the authorization medium is at least one of an integrated circuit card, a proximity card, a data card, a optical recording card and an impression transfer card.

75. An electronic storage medium according to claim 73, wherein the first recording medium is at least one of a hard drive, a network drive, a floppy disk, a compact disk, a digital video disk, a non-removable hard drive, a zip disk, an optical recording disk and an electronic memory device.
